(19) United States
(12) Patent Application Publication
(10) Pub. No.: US 2014/0322685 A1
(43) Pub. Date: Oct. 30, 2014

(54) SYSTEMS AND METHODS FOR ENHANCING COGNITION VIA A PHYSICALLY INTUITIVE SPATIAL VISUALIZATION TASK

(71) Applicant: LUMOS LABS, INC., San Francisco, CA (US)

(72) Inventors: David Ethan KENNERLY, San Francisco, CA (US); Aaron KALUSZKA, Hayward, CA (US); Joseph L. HARDY, Richmond, CA (US); Benjamin Lee AHRONI, San Francisco, CA (US)

(73) Assignee: LUMOS LABS, INC., San Francisco, CA (US)

(21) Appl. No.: 14/263,420

(22) Filed: Apr. 28, 2014

Related U.S. Application Data
(60) Provisional application No. 61/817,234, filed on Apr. 29, 2013.

(51) Int. Cl. G09B 19/00; G09B 5/00

(52) U.S. Cl. CPC G09B 19/00; G09B 5/00
USPC 434/236

(57) ABSTRACT

A method and system for training cognitive ability which may comprise a system and method for training a spatial visualization aspect of the cognitive ability of a user, which may comprise conducting, via a user computing device user interface display, a trial that may comprise presenting, a container having a plurality of sections, each with a plurality of corresponding sub-sections configured to fold upon one another; displaying at least one object occupying a sub-section of a first section and at least one object occupying a sub-section of the second section; allowing the user to manipulate the position of at least one object in at least one of the sub-sections of at least one of the first section and the second section, so as to avoid interference by any object in the first section with any object in the second section when corresponding sub-sections are folded upon one another.

### RELATED CASES

This application claims priority to U.S. Provisional Patent Application Ser. No. 61/817,234, entitled, SYSTEMS AND METHODS FOR ENHANCING COGNITION VIA A PHYSICALLY INTUITIVE SPATIAL VISUALIZATION TASK filed on Apr. 29, 2013, the disclosure of which is incorporated in the present application for all purposes as if the Provisional Application, including the entire specification, claims and drawing were repeated here fully and completely.

### BACKGROUND OF THE INVENTION

Spatial visualization refers to the mental manipulation of spatial information to determine how a given spatial configuration would appear if portions of that configuration were to be rotated, folded, repositioned, or otherwise transformed. This ability to manipulate mentally two-dimensional and three-dimensional figures, builds upon spatial orientation abilities by including the performance of serial operations.

Spatial visualization abilities are especially important in certain occupations such as architecture, design, and engineering, in order to interpret and produce visual representations of three-dimensional objects, and, for example, training architects to perform related tasks more quickly and accurately. See, Salthouse, T. A., Babcock, R. L., Skovronek, E., Mitchell, D. R. D., and Palmon, R. (1990), Age and Experience Effects in Spatial Visualization, Developmental Psychology, 26(1), 128-136.

Researchers have used visualization tasks as part of measures of general intelligence. A common measure of visualization is the Paper Folding Task, in which a piece of paper is shown folded with holes punched through it, and subjects must determine what the paper will look like once unfolded. See, Ekstrom, R. B., French, J. W., Harman, H. H., and Derman, D. (1976), Manual for Kit of Factor-Referenced Cognitive Tests, 173-179, Princeton, N.J.: Educational Testing Service. The folding task has ecological validity in that the process of mentally folding an object relates to temporal parameters involved in performing the same task physically. See, Shepard, R. N. and Feng, C. (1972), A Chronometric Study of Mental Paper Folding, Cognitive Psychology, 3(2), 228-243. Including a physically intuitive component to the task strengthens this relationship.

### SUMMARY

In this specification, a cognitive training exercise is disclosed that trains human visualization systems in an intuitive, engaging, and adaptively challenging way to enhance cognition. According to aspects of the disclosed subject matter, users can be engaged in a task where they are presented with a container, e.g., in the form of a partially filled suitcase, partitioned by a grid. Users must visualize where the objects in the suitcase will end up relative to one another once the container is modified, e.g., the suitcase is closed, e.g., by having initially displayed portions, e.g., halves, folded in a certain direction(s). Objects can also be required to moved such that the container (suitcase) will close without items overlapping. That is, given the assumption that the item are too thick for the container (suitcase) to be folded with more than one object in the same corresponding portion of the sections of, e.g., a folding multi-sectional suitcase.

It will be understood by those in the art that a method and system for training cognitive ability is disclosed which may comprise a system and method for training a spatial visualization aspect of the cognitive ability of a user, which may comprise conducting, via a user computing device user interface display, a trial that may comprise presenting, via the user computing device user interface display, a container having a plurality of sections, each with a plurality of corresponding sub-sections configured to fold upon one another; displaying, via the user computing device user interface display, at least one object occupying a sub-section of a first section and at least one object occupying a sub-section of the second section; allowing the user, via the user computing device user interface display, to manipulate the position of at least one object in at least one of the sub-sections of at least one of the first section and the second section, so as to avoid interference by any object in the first section with any object in the second section when corresponding sub-sections are folded upon one another.

The system and method may comprise the container comprising a multi-section suitcase having at least a first section and a second section, each separated into corresponding sub-sections which overlap when the at least a first section is folded upon the at least a second section. Allowing the user to manipulate the position of at least one object may comprise allowing the user, via the user computing device interface display, to one of initially position and reposition the object into or within a respective sub-section. At least one overlapping object may extend across a boundary between adjacent sub-sections within one of the first section and the second section; and allowing the user to manipulate the position of the at least one overlapping object may comprise by allowing the user to rotate the object in relation to the sub-section. The at least one overlapping object may extend across at least two boundaries between respective adjacent sub-sections, and allowing the user to manipulate the position of the at least one overlapping object may comprise by rotating the object in relation to the section.

The system and method may further comprise scoring, via the user computing device, the result of the user manipulating the position of at least one object in at least one of the sub-sections of at least one of the first section and the second section, so as to avoid interference by any object in the first section with any object in the second section when corresponding sub-sections are folded upon one another. The system and method may comprise timing, via the user computing device, how long the user takes to manipulate the position of at least one object in at least one of the sub-sections of at least one of the first section and the second section, so as to avoid interference by any object in the first section with any object in the second section when corresponding sub-sections are folded upon one another.

A tangible machine readable medium storing instructions is also disclose that, when executed by a computing device, cause the computing device to execute a method of training a spatial visualization aspect of the cognitive ability of a user, which method may comprise presenting on a user computing device user interface display, a container having a plurality of sections, each with a plurality of corresponding sub-sections configured to fold upon one another; displaying at least one object occupying a sub-section of a first section and at least one object occupying a sub-section of the second section; allowing the user to manipulate the position of at least one object into or within at least one of the sub-sections of at least one of the first section and the second section, so as to avoid interference by any object in the first section with any object in the second section when corresponding sub-sections are folded upon one another.

### INCORPORATION BY REFERENCE

All publications, patents, and patent applications mentioned in this specification are herein incorporated by reference to the same extent as if each individual publication, patent, or patent application was specifically and individually indicated to be incorporated by reference, for all purposes and as if the entire publication, patent or patent application were repeated in the present application verbatim, including any specification, claims and drawing. Such documents would include the articles referenced above and patents and publications of interest to the field include, for example, U.S. Pat. No. 7,773,097 for Visual Emphasis for Cognitive Training Exercises; and U.S. Pat. No. 7,540,615 for Cognitive Training Using Guided Eye Movements.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosed subject matter and its operation are utilized, and the accompanying drawings of which:

FIG. 1 is a screenshot that illustrates an exemplar container design where the camera is the only item that is moveable according to aspects of the disclosed subject matter;

FIGS. 2A-B are frames of animation that illustrates how a suitcase closes, and as illustrated in FIG. 2B, the folding sections can become translucent so that the user can see how the objects relate to each other in a space according to aspects of the disclosed subject matter;

FIG. 3 is a screenshot that illustrates an example of correct placement, with an indicator (such as a check) that visually indicates correctness according to aspects of the disclosed subject matter;

FIG. 4 is a is a screenshot of an object placed incorrectly, with an indicator (such as an X) that visually indicates incorrectness according to aspects of the disclosed subject matter;

FIG. 5 is a flow diagram illustrating an example of the behavior of a first vs. subsequent plays according to aspects of the disclosed subject matter;

FIG. 6 is a flow diagram illustrating an example of tutorial flow according to aspects of the disclosed subject matter;

FIG. 7 is a screen shot of a title screen according to aspects of the disclosed subject matter;

FIGS. 8A-B are screen shots of a tutorial describing a method of interaction through a series of prompts according to aspects of the disclosed subject matter;

FIG. 9 is a screen shot illustrating an ending for a tutorial according to aspects of the disclosed subject matter;

FIG. 10 is a flow diagram illustrating an example of game flow according to aspects of the disclosed subject matter;

FIG. 11 is a flow diagram illustrating an example of trial flow according to aspects of the disclosed subject matter;

FIG. 12 is a screen shot illustrating the additional complexity of more sections according to aspects of the disclosed subject matter;

FIG. 13 is a screen shot illustrating the additional complexity of both horizontal and vertical hinges connecting the sections according to aspects of the disclosed subject matter;

FIG. 14 is a screen shot illustrating the additional complexity of a diagonal hinge connecting the sections according to aspects of the disclosed subject matter; and

FIG. 15 is a screen shot illustrating an exemplar final screen shot with a user's score according to aspects of the disclosed subject matter.

### DETAILED DESCRIPTION OF THE INVENTION

### I. Computing Systems

The systems and methods described herein rely on a variety of computer systems, networks and/or digital devices for operation. In order to fully appreciate how the system operates, an understanding of suitable computing devices and systems is useful. The computing devices, systems and methods disclosed herein are enabled as a result of application via a suitable computing device (including without limitation mobile devices such as mobile phones and tablets).

In at least some configurations, a user executes a browser to view digital content items and can connect to the front end server via a network, which is typically the Internet, but can also be any network, including but not limited to a mobile, wired or wireless network, a private network, or a virtual or ad hoc private network. As will be understood very large numbers (e.g., millions) of users are supported and can be in communication with the website at any time. The user may utilize a variety of different computing devices. Examples of user devices include, but are not limited to, personal computers, digital assistants, personal digital assistants, cellular phones, mobile phones, smart phones, tablets or laptop computers.

The browser can include any application that allows users to access web pages on the World Wide Web. Suitable applications include, but are not limited to, Microsoft Internet Explorer®, Netscape Navigator®, Mozilla® Firefox, Apple® Safari or any application capable of or adaptable to allowing access to web pages on the World Wide Web. The browser can also include Flash™ from Adobe Systems, Inc.).

In at least some configurations, a user may download an App, e.g., onto the user's portable communication device, and play the cognitive training spatial visualization game on the user's hand held device or other user computing device. An aspect of the disclosure is directed to enabling a user to place an object in a particular position in a container, e.g., one section (e.g., a section of a suitcase) of a multi-section display in a position such that when a first section is rotated about a particular axis(es) connecting the first section to a second section, (e.g., when the suitcase is closed) the objects contained in the other sections do not overlap and collide with the object positioned by the user. The exercise requires that the user visualize how each object will be transformed in space once the container 300 closes and make a decision based on this mental visualization.

### II. Software Programs Implementable in the Computing and Network Environments to Achieve a Desired Technical Effect or Transformation

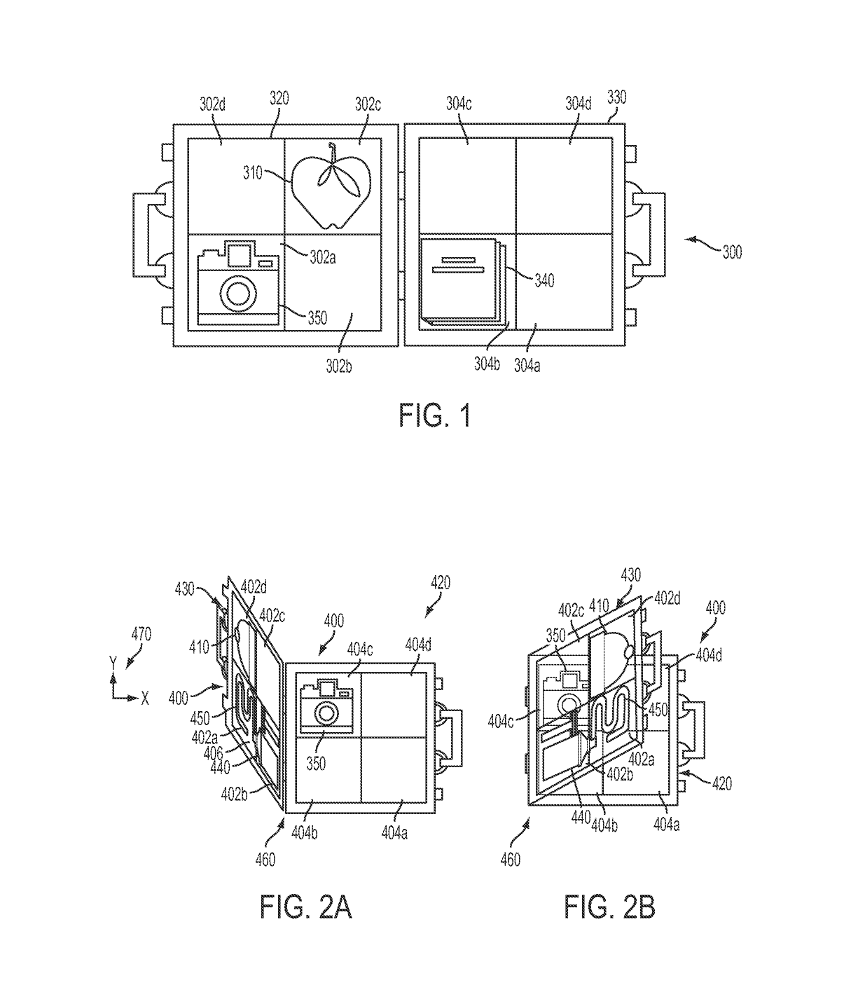

The core gameplay mechanism is the selection of the final position of an object, which in one implementation can be represented by a camera 350 (FIG. 1). The camera 350 can be initially positioned in a single sub-section 302a of the container 300, i.e., from among the sub-sections 302a-d of the section 320. The final position of the camera could be selected by pointing and clicking the desired location with a computer mouse, by moving the camera to a desired location using directional keys on the keyboard, or by touching the location desired on a touch-sensitive device. As illustrated, the second section 330, also divided into sub-sections 304a-d can have an object positioned therein. Multiple objects could be placed in each section such as the apple 310 in the sub-section 302c of the section 320 and the book 340 in sub-section 304d of the section 330. As will be appreciated by those skilled in the art, other objects could take up larger areas than a 1×1 block. In such an implementation, the option to rotate the object could be made available, e.g. to free up a sub-section 302 previously covered.

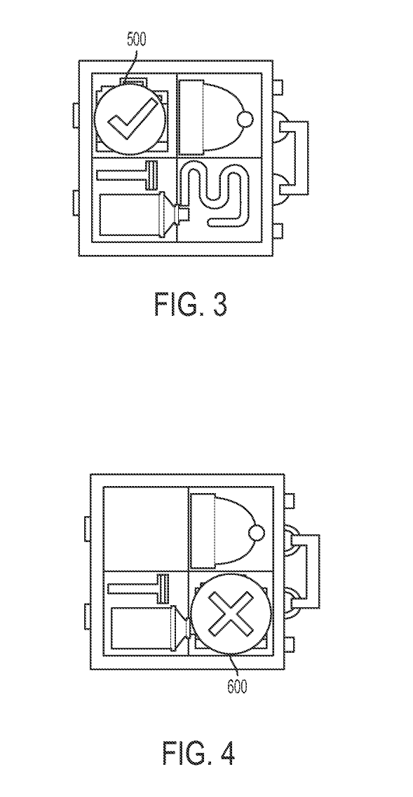

The configuration of a container 400 can be determined by a current level of difficulty and can be designed to provide a smooth transition between trials. When the position for the object (such as camera 350) within a sub-section 404c of the section 420 is selected, the container closes (FIGS. 2A-B) about a vertical axis 460, e.g., corresponding to the Y axis of an X-Y coordinate system 470. A correct trial occurs if, when the container 400 is closed, the camera 350 in sub-panel 404c of panel 420 does not interfere with the placement of other objects, such as of the hat 410, in the sub-section 402d, the shaving cream 450, in the sub-section 402a, or then shaving cream can/razor combination 440, in a sub-section 402b. That is, in a correct trial, when the container 400 is closed, the empty sub-section 402c of panel 430 makes way for the camera 350 in the corresponding sub-section 404c of the section 430. The container 400 can be indicated to be partly transparent, e.g., in panel 430 as seen in FIG. 2B, as the container 400 is closing, to better indicate to the user whether such interference occurred. Additionally, an indication of success can appear and the user can be rewarded for a correct trial (as indicated, e.g., by the check mark 500 in FIG. 3).

It will also be understood that objects themselves may extend over a sub-section to sub-section boundary, such as the shaving cream can top 406 in the shaving cream can/razor combination 440 and other objects, such as the shaving cream 450 may not cover the entire adjacent sub-section area footprint. In this manner, users may be required to take these coverage differences into account in considering, e.g., the proper placement of the objects in adjoining sub-sections, and, e.g., rotation of such objects, were, e.g., either the shaving cream 450 and/or the shaving cream can/razor combination 440 is the subject of being placed by the user, e.g., in adjacent sub-section compartments. If any object does overlap, the user can then be given an indication that the positioning of the object(s) was not correct. Such an indication can be given by, for example, closing the container 400 more slowly to note the improper placement, and/or not closing the container 400 fully and/or the appearance of an associated incorrect indicator (e.g., as indicated by the X 600 in FIG. 4). As indicated and illustrated in FIG. 2B, to facilitate the user's experience, the folding sections can be made translucent while closing so that the user can see how the objects fit together or do not fit together when the container 400 is closed. The correct 500 and incorrect 600 indicators can be visual as indicated above and/or include an auditory indicator.

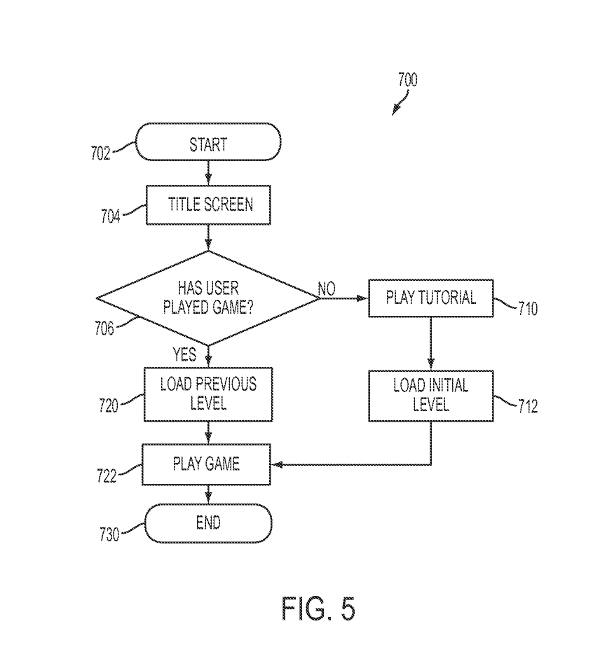

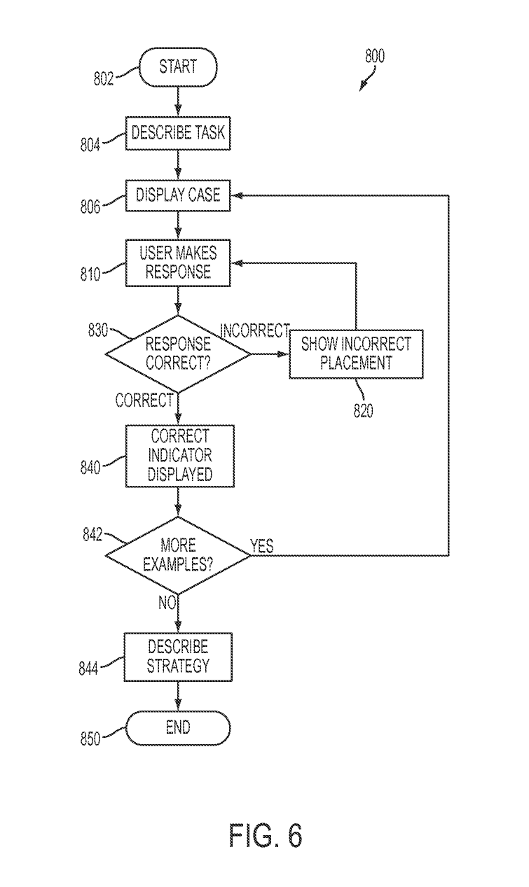

The user can be introduced to the training exercise via a short interactive tutorial describing the gameplay elements (e.g., as illustrated, e.g., by the program process flow diagrams 700 and 800 in FIGS. 5-6). As shown in FIG. 5, once the process 700 is started in start block 702, a title screen is caused to appear, on the user's device in block 704, after which it may be determined whether the user has played the game before in block 706, e.g., by displaying such a question to the user. If the user has not played the game before a tutorial can be started in block 710 after which an initial level of game play can be initiated in block 712. If the user has played the game before, then the previously played level can be loaded in block 720. Thereafter the user can be enabled to play the game in block 722 until such time as the user elects to end the session in block 730. As will be appreciated by those skilled in the art, but not illustrated in FIG. 5, a user who has played previously can elect to again play the tutorial (e.g., where the user has not played in a long time, wishes to check on a certain rule or process of play, etc.).

As shown in FIG. 6, once the process 800 for the game is started in block 802, the task involved in the game can be described in block 804, e.g., by giving the title of the game or a brief description of the purpose/objectives of the game, etc., followed by causing to be displayed in block 806, for example, a container 400, to which the user can then provide a response in block 810, e.g., selecting a sub-section location into which to place or move an object shown in the container 400, e.g., according to the rules of the game play. If the response is correct, as determined, e.g., in block 830, a correct indicator can be displayed in block 840. If the response is incorrect, the user may be shown the incorrect placement in block 820 and given the opportunity to enter another response in block 810. Once a correct indicator is displayed, more examples can be provided, e.g., in block 842, with a feedback loop back to block 806, which can result in displaying a new container 400. If the user does not elect to repeat, then the strategy can be described in block 844 or a session score can be provided prior to ending the session in block 850.

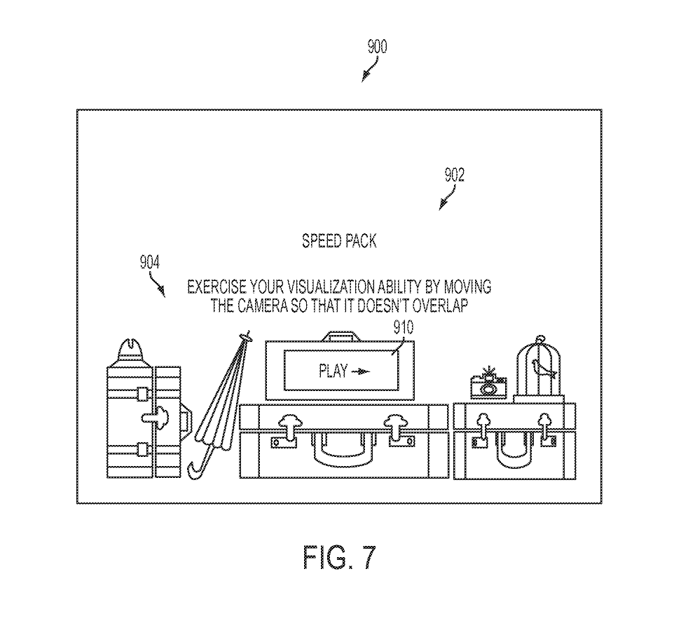

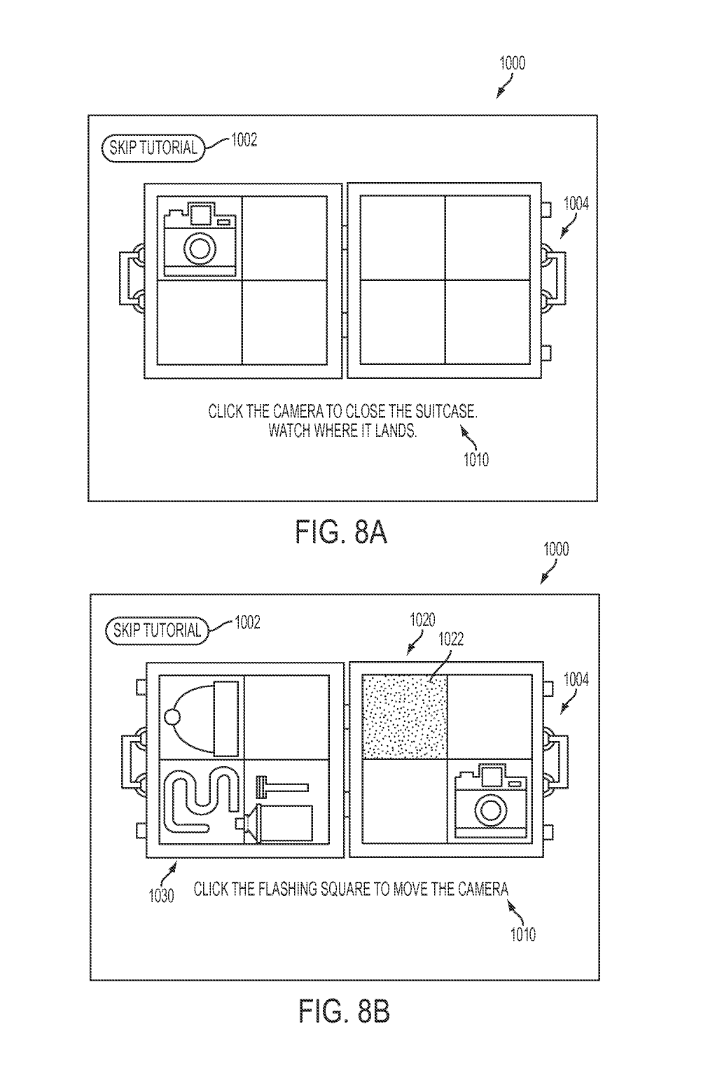

The tutorial can prompt the user to complete a series of simple game configurations with guided messages and prompts (e.g., as indicated in FIGS. 7, 8A-B, and 11). Important gameplay features such as how the elements of suitcase/container 400 are positioned when opened and closed can be explained, e.g., with animations. As an example, the display 900 in FIG. 7 can show a game name such as “SPEED PACK” 902, and provide a brief explanation such as “Exercise your visualization abilities by moving the camera so that it doesn't overlap,” as illustrated at 904. A start or play button 910 can also be displayed. Interactive feedback can be used to inform the user of success in understanding and eventually completing the task, and player can be given the chance to retry after making an error. After a number of successful trials, the player can be invited to start the game. The tutorial may be recalled in the future if a player needs to be reminded how to play or dismissed if not needed. The display can also have a “Skip Tutorial” button 1002.

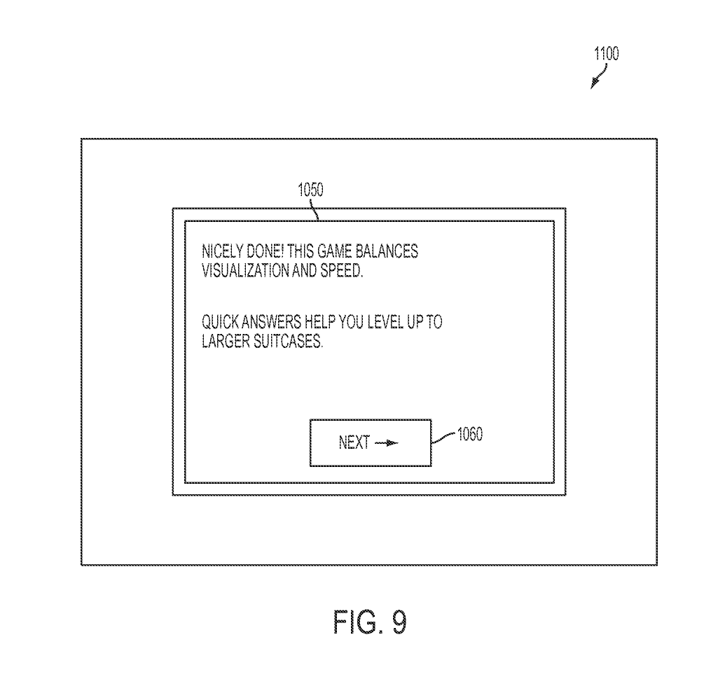

By way of example, as illustrated in FIG. 8A a screen display 1000 for a tutorial can display an open container/suitcase 1004 and instructions 1010 “Click the camera to close the suitcase. Watch where it lands.” As illustrated by way of example in FIG. 8B, the suitcase 1004, as discussed above, can be shown with the two sections 1020 and 1030 containing items in their respective sub-sections, with the instructions 1010 “Click the flashing square [1022] to move the camera.” As illustrated in FIG. 9, the tutorial section 1100 can then display a congratulations note pop-up 1050, “Nicely done! This game balances visualization and speed. Quick answers help you level up to larger suitcases.” A next button 1060 can be displayed for moving out of the tutorial.

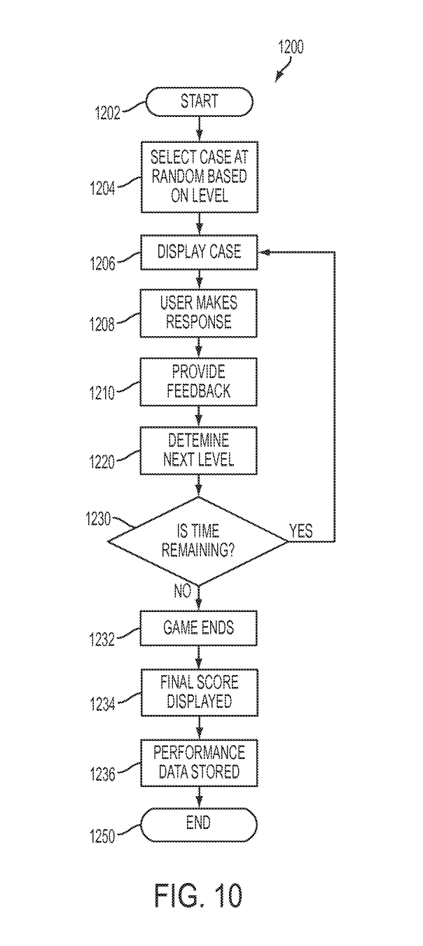

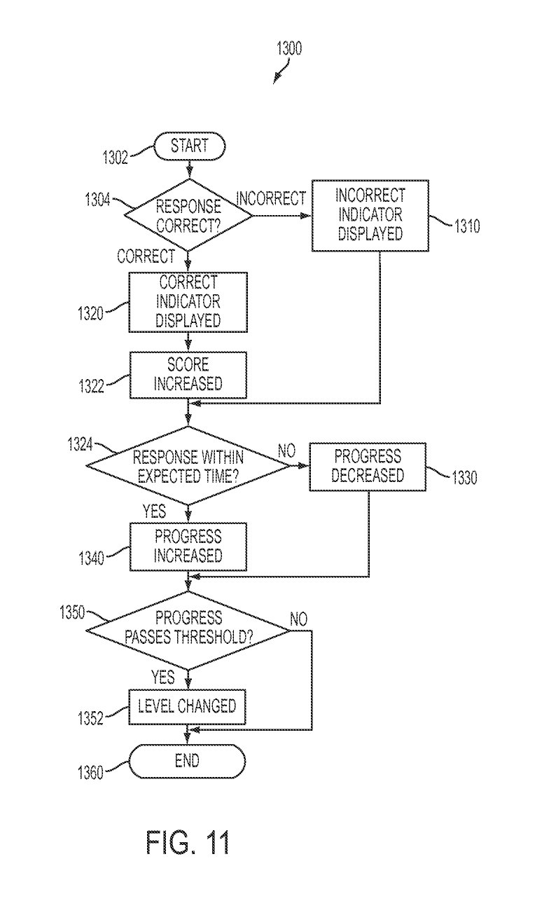

In an example of the main gameplay flow, shown in gameplay process flow diagram 1200, of FIG. 10, there can be varying levels of difficulty. After starting, at block 1202, a container/suitcase 400 can be selected at random based on difficulty level, e.g., from a library of pre-constructed containers 400, or from a selection of a type of container 400, and random location of, e.g., several items in one section 420 of the container 400 and one or more, e.g. the camera, positioned in a randomly selected location in the other section 430 of the container 400. The container 400 can then be displayed in block 1206. The user can then be asked to make a response, e.g., in block 1208, and the system can then provide feedback regarding the accuracy of the response in block 1210. After this, the next level can be determined in block 1220. Thereafter, if time is remaining, as determined in block 1230, another container 400 can be so displayed by feedback from block 1230 to block 1206. If additional time is not remaining, then the game can be ended in block 1232, a final score displayed in block 1234, and performance data may be stored in block 1236, after which the program ends in block 1250. The difficulty level can be reassessed after each trial (as illustrated, e.g., in FIG. 11) as shown in the process flow diagram 1300. In one implementation, a variable representing progress can be stored internally and may be displayed to the user. When a user correctly answers a trial, e.g., in block 1304, the correct indicator can be displayed in block 1320 and, e.g., a ratio of the time taken to expected time can be added to the progress variable, i.e., the user score increased on block 1322. If the response was determined to be within some threshold of time in block 1324, a progress variable can be increased in block 1340; otherwise, it can be decreased block 1330. When this progress variable (also stored internally) crosses a threshold, as determined in block 1350, the difficulty level can be adjusted based on the change in the variable, e.g., either increased or decreased in block 1352. This threshold, though not shown in the flow diagram of FIG. 11, can also be related to the expected time taken to complete a particular level, as opposed to completing individual game-play tasks within the level, which may also be normalized, e.g., by being calculated from the range of response times at each level taken from a large number of users. Other implementations could instead increase or decrease levels based on a number of consecutive correct or incorrect trials, respectively, or use a Bayesian adaptive algorithm to predict the optimal level for a user at a given time, or by other means as will be understood by those in the art.

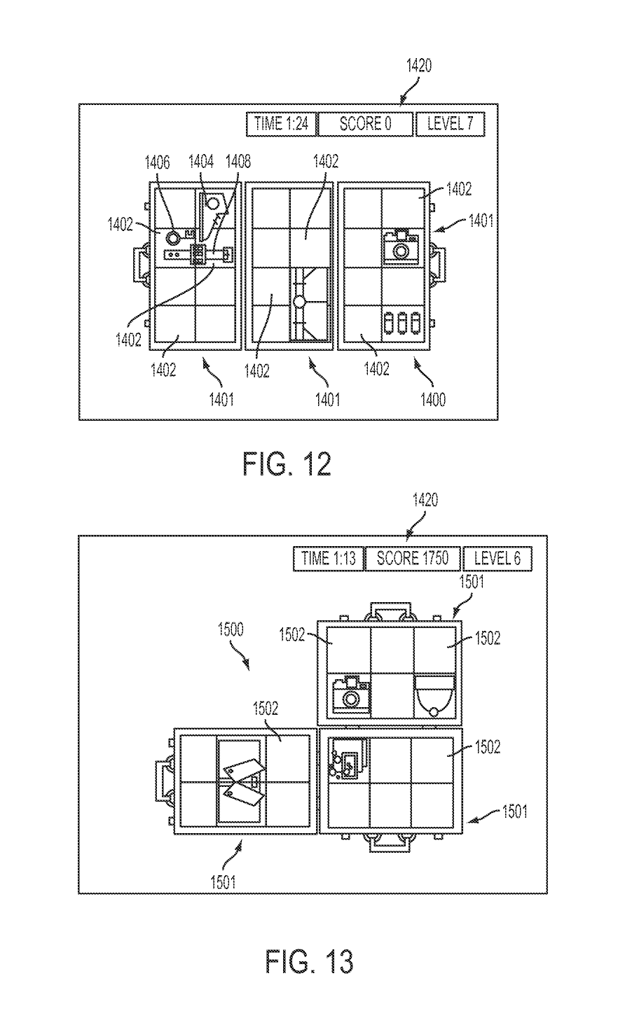

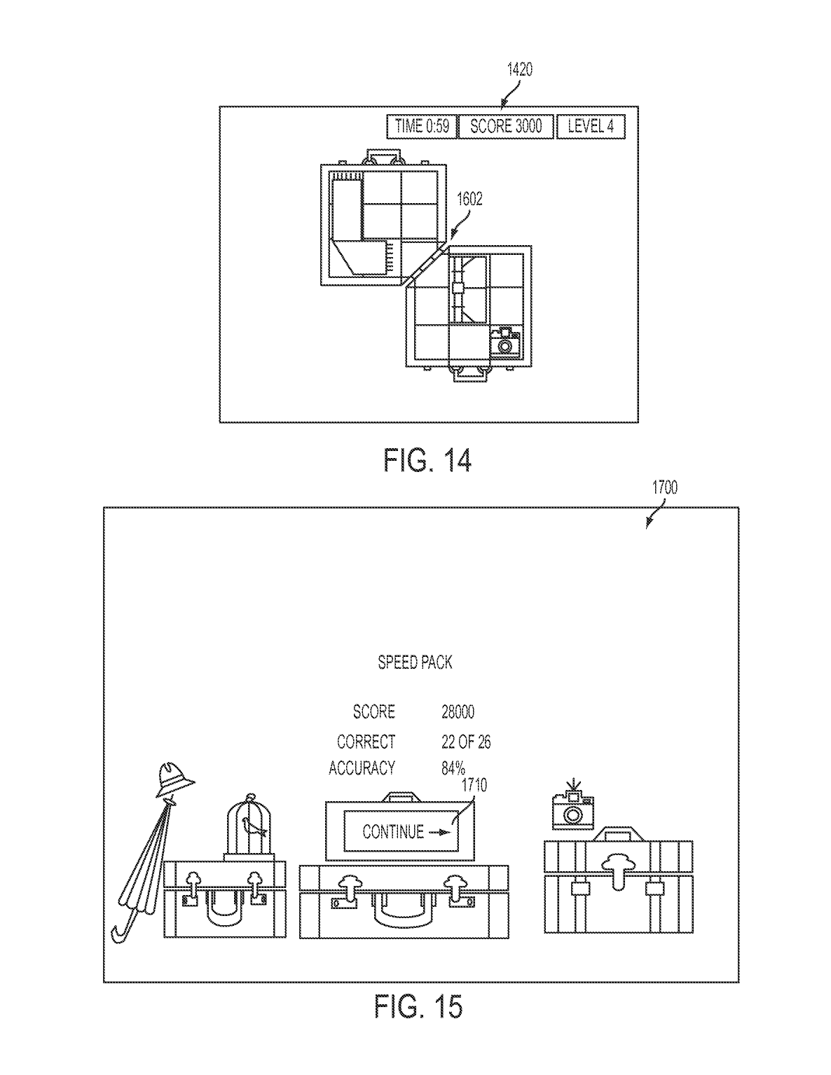

Difficulty may also be controlled, e.g., by adjusting the following variables. The numbers and designs represent applicants' currently understood implementation(s), but other implementations could vary each aspect: container 400 size (the game can, e.g., begin with cases made of four sub-sections and increases up to, e.g., nine sub-sections; number of sections (hinges) in the container 400 (the game can begin with two sections and increases up to, e.g., four sections (three being illustrated by way of example in FIG. 12); angle of hinges (the game can begin with a vertical hinge and later introduce combinations of vertical, horizontal, and diagonal hinges (as illustrated by way of example in FIGS. 13-14); number and position of objects within each sub-section (e.g., cases can vary from half full to completely full); and expected response time (the time allotted to solve a container 400 can be reduced at higher levels). FIG. 13 illustrates, by way of example, a container 1400, with sections 1401 and sub-sections 1402. In the sections, items, such as the sneaker 1404 and the belt 1408, can overlap sub-section boundaries and/or can share a subsection, e.g., as with the key 1406 and the be lot 1402.

The process of generating a dynamic board configuration can begin with the selection of a container 400. According to aspects of embodiments of the disclosed subject matter, each container 400 design can be associated with a difficulty level, and these associations may be generated by recording response times for each configuration from a large sample of players, and assigning those configurations that take longer to solve to higher difficulty levels. Each level can alternatively include a set of containers 400 from which one is selected randomly. The position of items within the containers 400 can be randomized to encourage visualization rather than memorization of configurations. Since the containers 400 and positions can be dynamically generated, a very large number of unique trials exist to be presented to the user. Other methods of selecting containers 400 or assigning difficulty could be used. The score reward given to a user can be based on the current level, but other factors, such as response time, could be incorporated, such as whether the response time fell under a particular threshold for a given level.

The current level, score, and time remaining can be displayed to the user, e.g., on an game information bar 1420, as can be seen in FIGS. 12, 13 and 14, as a measure of progress. As an example, after a fixed time interval (e.g., 90 seconds, which can be dynamically adjusted based on the user's performance), or some other measure (e.g., number of trials completed) the user's game can be completed and the user can be shown a results screen on which the score of the user is displayed alongside the number of cases successfully completed and the accuracy achieved (as illustrated illustratively in FIG. 17). Other statistics may also be presented, such as highest level reached, average time per container 400, etc. FIG. 13 illustrates, by way of example, a container 1500 having sections 1501, foldable on two different orthogonal axes, and sub-sections 1502. The container 1600 of FIG. 14 is shown, e.g., to contain two sections foldable on a diagonal axis 1602. FIG. 15 illustrates, e.g., an ending screen display 1700 for the game “Speed Pack” also indicating the score attained, the correct trials out of a total number of trials and the accuracy percentage.

The user's level on the last trial can be recorded and the user can begin at that level in the subsequent play of the game by the user. In other implementations, other factors could be incorporated to determine the new starting level.

The following is a disclosure by way of example of a known computing device which may be used with the presently disclosed subject matter. The description of the various components of a computing device is not intended to represent any particular architecture or manner of interconnecting the components. Other systems that have fewer or more components may also be used with the disclosed subject matter. A communication device may constitute a form of a computing device and may at least include, contain, utilize or emulate a computing device. In this description, various functions, functionalities and/or operations may be described as being performed by or caused by software program code to simplify description. However, those skilled in the art will recognize that what is meant by such expressions is that the functions resulting from execution of the program code/instructions are performed by a computing device as described in the present application, e.g., including a processor, such as a microprocessor, microcontroller, logic circuit or the like noted above.

Thus, the techniques are limited neither to any specific combination of hardware circuitry and software, nor to any particular tangible source for the instructions executed by the data processor(s) within the computing device, such as a tangible machine readable medium. In other words, as an example only, part or all of the machine readable medium may in part or in full form a part of the, or be included within the computing device itself, e.g., by hard wiring or pre-programmed instructions in any memory utilized by or in the computing device.

While some embodiments can be implemented in fully functioning computers and computer systems, various embodiments are capable of being distributed as a computing device including, e.g., a variety of architecture(s), form(s) or component(s). Embodiments may be capable of being applied regardless of the particular type of machine or tangible machine/computer readable media used to actually affect the performance of the functions and operations and/or the distribution of the performance of the functions, functionalities and/or operations.

At least some aspects of the disclosed subject matter can be embodied, at least in part, in programmed software code/instructions. That is, the functions, functionalities and/or operations and techniques may be carried out in a computing device or other data processing system in response to its processor, such as a microprocessor, executing sequences of instructions contained in a memory or memories, such as ROM, volatile RAM, non-volatile memory, cache or a remote storage device. In general, the routines executed to implement the embodiments of the disclosed subject matter may be implemented as part of an operating system or a specific application, component, program, object, module or sequence of instructions usually referred to as a “computer program(s),” or “software.” The computer program(s) typically comprise instructions stored at various times in various tangible memory and storage devices, e.g., in a computing device, such as in cache memory, main memory, internal disk drives, and/or above noted forms of external memory, such as remote storage devices, such as a disc farm, remote memory or databases, e.g., accessed over a network, such as the Internet. When read and executed by a computing device, e.g., by a processor(s) in the computing device, the computer program causes the computing device to perform a method(s), e.g., process and operation steps to execute an element(s) as part of some aspect(s) of the system(s) or method(s) of the disclosed subject matter.

A tangible machine readable medium can be used to store software and data that, when executed by a computing device, causes the computing device to perform a method(s) as may be recited in one or more accompanying claims defining the disclosed subject matter. The tangible machine readable medium may include storage of the executable software program code/instructions and data in various tangible locations as noted above. Further, the program software code/instructions can be obtained from remote storage, including, e.g., through centralized servers or peer to peer networks and the like. Different portions of the software program code/instructions and data can be obtained at different times and in different communication sessions or in a same communication session, e.g., with one or many storage locations.

The software program code/instructions and data can be obtained in their entirety prior to the execution of a respective software application by the computing device. Alternatively, portions of the software program code/instructions and data can be obtained dynamically, e.g., just in time, when needed for execution. Alternatively, some combination of these ways may be used for obtaining the software program code/instructions and data may occur, as an example, for different applications, components, programs, objects, modules, routines or other sequences of instructions or organization of sequences of instructions. Thus, it is not required that the data and instructions be on a single machine readable medium in entirety at any particular instant of time or at any instant of time ever.

In general, a tangible machine readable medium can include any tangible mechanism that provides (i.e., stores) information in a form accessible by a machine (e.g., a computing device), which may be included, e.g., in a communication device, a network device, a personal digital assistant, a mobile communication device, whether or not able to download and run applications from the communication network, such as the Internet, e.g., an iPhone, iPad, Kindle, Blackberry, Droid, or the like, a manufacturing tool, or any other device including a computing device, comprising, e.g., one or more data processors, etc. In an embodiment(s), a user terminal can be a computing device, such as in the form of or included within a PDA, a cellular phone, a notebook computer, a personal desktop computer, etc. Alternatively, any traditional communication client(s) may be used in some embodiments of the disclosed subject matter. While some embodiments of the disclosed subject matter have been described in the context of fully functioning computing devices and computing systems, those skilled in the art will appreciate that various embodiments of the disclosed subject matter are capable of being distributed, e.g., as a system, method and/or software program product in a variety of forms and are capable of being applied regardless of the particular type of computing device machine or machine readable media used to actually effect the distribution.

The disclosed subject matter may be described with reference to block diagrams and operational illustrations or methods and devices to provide the system(s) and/or method(s) according to the disclosed subject matter. It will be understood that each block of a block diagram or other operational illustration (herein collectively, “block diagram”), and combination of blocks in a block diagram, can be implemented by means of analog or digital hardware and computer program instructions. These computing device software program code/instructions can be provided to the computing device such that the instructions, when executed by the computing device, e.g., on a processor within the computing device or other data processing apparatus, the program software code/instructions cause the computing device to perform functions, functionalities and operations of the system(s) and/or method(s) according to the disclosed subject matter, as recited in the accompanying claims, with such functions, functionalities and operations specified in the block diagram.

It will be understood that in some possible alternate implementations, the function, functionalities and operations noted in the blocks of a block diagram may occur out of the order noted in the block diagram. For example, the function noted in two blocks shown in succession can in fact be executed substantially concurrently or the functions noted in blocks can sometimes be executed in the reverse order, depending upon the function, functionalities and operations involved. Therefore, the embodiments of the system(s) and/or method(s) presented and described as a flowchart(s) in the form of a block diagram in the present application are provided by way of example only, and in order to provide a more complete understanding of the disclosed subject matter. The disclosed flow and concomitantly the method(s) performed as recited in the accompanying claims are not limited to the functions, functionalities and operations illustrated in the block diagram(s) and/or logical flow(s) presented in in the disclosed subject matter. Alternative embodiments are contemplated in which the order of the various functions, functionalities and operations may be altered and in which sub-operations described as being part of a larger operation may be performed independently or performed differently than illustrated or not performed at all.

Although some of the drawings may illustrate a number of operations in a particular order, functions, functionalities and/or operations which are not now known to be order dependent, or become understood to not be order dependent, may be reordered. Other functions, functionalities and/or operations may be combined or broken out. While some reordering or other groupings may have been specifically mentioned in the present application, others will be or may become apparent to those of ordinary skill in the art and so the disclosed subject matter does not present an exhaustive list of alternatives. It should also be recognized that the aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The disclosed subject matter is described in the present application with reference to one or more specific exemplary embodiments thereof. Such embodiments are provided by way of example only. It will be evident that various modifications may be made to the disclosed subject matter without departing from the broader spirit and scope of the disclosed subject matter as set forth in the appended claims. The specification and drawings are, accordingly, to be regarded in an illustrative sense for explanation of aspects of the disclosed subject matter rather than a restrictive or limiting sense. Numerous variations, changes, and substitutions will now occur to those skilled in the art without departing from the disclosed subject matter. It should be understood that various alternatives to the embodiments of the disclosed subject matter described as part of the disclosed subject matter may be employed in practicing the disclosed subject matter. It is intended that the following claims define the scope of the disclosed subject matter and that methods and structures within the scope of these claims and their equivalents be covered by the following claims.

What is claimed is:

1. A method of training a spatial visualization aspect of the cognitive ability of a user, comprising:
conducting, via a user computing device user interface display, a trial comprising:
presenting, via the user computing device user interface display, a container having a plurality of sections, each section comprising a plurality of corresponding sub-sections configured to fold upon one another when the first section is folded over the second section;
displaying, via the user computing device user interface display, at least one object occupying at least one sub-section of a first section and at least one object occupying at least one sub-section of the second section;
allowing the user, via the user computing device user interface display, to manipulate the position of at least one of the at least one object in the at least one sub-section of the first section and the at least one object in the at least one sub-section of the second section, so as to avoid interference by any object in the first section with any object in the second section when first section and second section are folded upon one another.

2. The method of claim 1 further comprising:
the container comprising a multi-section suitcase having at least a first section and a second section, each separated into corresponding sub-sections which overlap when the first section is folded upon the second section.

3. The method of claim 2 further comprising:
allowing the user to manipulate the position of the at least one object comprising allowing the user, via the user computing device interface display, to one of initially position and reposition the object into or within a respective sub-section.

4. The method of claim 3 further comprising:
at least one overlapping object extending across a boundary between adjacent sub-sections within one of the first section and the second section; and
allowing the user to manipulate the position of the at least one overlapping object by rotating the object in relation to the respective sub-section.

5. The method of claim 3 further comprising:
the at least one overlapping object extending across at least two boundaries between respective adjacent sub-sections, and
allowing the user to manipulate the position of the at least one overlapping object by rotating the object in relation to the section.

6. The method of claim 1 further comprising:
scoring, via the user computing device, the result of the user manipulating the position of at the least one object in at least one of the sub-sections of at least one of the first section and the second section, so as to avoid interference by any object in the first section with any object in the second section when corresponding sub-sections are folded upon one another.

7. The method of claim 6 further comprising:
timing, via the user computing device, how long the user takes to manipulate the position of at least one object in at least one of the sub-sections of at least one of the first section and the second section, so as to avoid interference by any object in the first section with any object in the second section when corresponding sub-sections are folded upon one another.

8. An apparatus for training a spatial visualization aspect of the cognitive ability of a user, comprising:
a user computing device configured to present on a user computing device user interface display a trial comprising:
presenting a container having a plurality of sections, each section comprising a plurality of corresponding sub-sections configured to fold upon one another when the first section is folded over the second section;
displaying at least one object occupying at least one sub-section of a first section and at least one object occupying at least one sub-section of the second section;
allowing the user to manipulate the position of at least of the at least one object in at least one sub-section of the first section and the at least one object in the at least one sub-section of the second section, so as to avoid interference by any object in the first section with any object in the second section when first section and the second section are folded upon one another.

9. The apparatus of claim 8 further comprising:
the container comprising a multi-section suitcase having at least a first section and a second section, each separated into corresponding sub-sections which overlap when the at least a first section is folded upon the second section.

10. The apparatus of claim 9 further comprising:
allowing the user to manipulate the position of the at least one object comprising allowing the user to one of initially position and reposition the object into or within a respective sub-section.

11. The apparatus of claim 10 further comprising:
at least one overlapping object extending across a boundary between adjacent sub-sections within one of the first section and the second section; and
allowing the user to manipulate the position of the at least one overlapping object comprises allowing the user to rotate the object in relation to the respective sub-section.

12. The apparatus of claim 10 further comprising:
the at least one overlapping object extending across at least two boundaries between respective adjacent sub-sections, and
allowing the user to manipulate the position of the at least one overlapping object by rotating the object in relation to the section.

13. The apparatus of claim 8 further comprising:
the user computing device configured to score the result of the user manipulating the position of at least one object at least one of the sub-sections of at least one of the first section and the second section, so as to avoid interference by any object in the first section with any object in the second section when corresponding sub-sections are folded upon one another.

14. The apparatus of claim 13 further comprising:
the user computing device configured to time how long the user takes to manipulate the position of the at least one object in at least one of the sub-sections of at least one of the first section and the second section, so as to avoid interference by any object in the first section with any object in the second section when corresponding sub-sections are folded upon one another.

15. A tangible machine readable medium storing instructions that, when executed by a computing device, cause the computing device to execute a method of training a spatial visualization aspect of the cognitive ability of a user, the method comprising:
conducting a trial comprising:
presenting a container having a plurality of sections, each section comprising a plurality of corresponding sub-sections configured to fold upon one another when the first section is folded over the second section;
displaying at least one object occupying at least one sub-section of a first section and at least one object occupying at least one sub-section of the second section;
allowing the user to manipulate the position of at least of the at least one object in at least one sub-section of the first section and the at least one object in the at least one sub-section of the second section, so as to avoid interference by any object in the first section with any object in the second section when first section and the second section are folded upon one another.

16. The machine readable medium of claim 15, the method further comprising:
the container comprising a multi-section suitcase having at least a first section and a second section, each separated into corresponding sub-sections which overlap when the first section is folded upon the second section.

17. The machine readable medium of claim 16, the method further comprising:
allowing the user to manipulate the position of the at least one object comprising allowing the user, via the user computing device interface display, to one of initially position and reposition the object in or within a respective sub-section.

18. The machine readable medium of claim 17, the method further comprising:
at least one overlapping object extending across a boundary between adjacent sub-sections within one of the first section and the second section; and
allowing the user to manipulate the position of the at least one overlapping object by rotating the object in relation to the sub-section.

19. The machine readable medium of claim 17, the method further comprising:
the at least one overlapping object extending across at least two boundaries between respective adjacent sub-sections, and
allowing the user to manipulate the position of the at least one overlapping object by rotating the object in relation to the respective sub-section.

20. The machine readable medium of claim 15, the method further comprising:
scoring the result of the user manipulating the position of at least one object in at least one of the sub-sections of the at least one of the first section and the second section, so as to avoid interference by any object in the first section with any object in the second section when corresponding sub-sections are folded upon one another.
